(19) United States
(12) Patent Application Publication
(10) Pub. No.: US 2026/0073655 A1
(43) Pub. Date: Mar. 12, 2026

(54) VIDEO CAMERA WITH HEMISPHERIC FIELD OF VIEW

(71) Applicant: MOTOROLA SOLUTIONS, INC., CHICAGO, IL (US)

(72) Inventors: JOEL GEDDERT, VANCOUVER (CA); DANIEL FRANKE, BERTHOUD, CO (US); KWANG CHUN OH, GEORGETOWN (MY)

(21) Appl. No.: 18/829,344

(22) Filed: Sep. 10, 2024

(51) Int. Cl. G06V 10/10; H04N 23/63; H04N 23/695

(52) U.S. Cl. CPC G06V 10/16; H04N 23/635; H04N 23/695

(57) ABSTRACT

A device, system and method for generating a full hemispheric view with no blind spots are described. A plurality of image are positioned in an interleaved configuration. A first type of image sensor view is generated by a first type of the plurality of image sensors. A second type of image sensor view is generated by a second type of the plurality of image sensors. The first type of image sensor view and the second type of image sensor view are stitched together into a full hemispheric image sensor view. A visual obstruction from the full hemispheric image sensor view is removed based on the stitching into the full hemispheric image sensor view.

### BACKGROUND OF THE INVENTION

In conventional operation, cameras have a limited effective field of view. For example, panoramic cameras may generate incomplete hemispheric views due to having blind spots. Additionally, fisheye cameras can have wide field of views up to 360 degrees but at a very distorted quality and low effective pixels per degree. Cameras with blind spots may be more susceptible to failing to deter security violations such as vandalism. A camera that provides a complete hemispheric view (e.g., full field of view above and below horizon) having no blind spots and with effective identification details could improve video surveillance.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts example configuration details of a multisensor full hemispherical video camera, in accordance with some examples.

FIG. 2 depicts top and front views of an example full hemispherical video camera, in accordance with some examples.

FIG. 3 depicts an isometric view of an example full hemispherical video camera, in accordance with some examples.

FIGS. 4-5 illustrates shortcomings of camera operation with various blind spots, in accordance with some examples.

FIG. 6 illustrates a workflow for stitching multiple sensor views together into a full hemispheric image sensor view, in accordance with some examples.

FIG. 7 illustrates a block diagram of an example electronic device, in accordance with some examples.

FIG. 8 is a flowchart of a method for generating a full hemispheric view, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

It may be challenging to conduct video surveillance and security with a camera having a limited field of view (FOV). For example, a camera with a blind spot such as directly below the camera may incur risks in the potential occurrence of vandalism to the camera as well as other potential security violations. A conventional fisheye camera can have a wide FOV up to 360 degrees but with heavy distortion and very small pixels per degree. A conventional panoramic camera can address this distorted fisheye image but with the limitation of blind spots below the camera. It may be desirable to improve video camera FOV that yields a full FOV both below and above the camera (i.e., no blind spots) at a non-distorted hemispheric FOV (due to projecting a sphere on a plane, distortion/warp below the camera will progressively increase as distance from the horizontal plane increases).

The present disclosure provides a technical solution to the particular technical challenges of achieving a non-distorted panoramic hemispheric FOV in a single camera. In particular, a configuration of multiple image sensors arranged with overlapping FOV such that a non-distorted panoramic view can be achieved without blind spots via stitching. For example, one common sensor and lens design can be achieved by stitching the respective image sensor views to have a panoramic above horizon hemispheric view and no blind spots below the camera (e.g., the constituent image sensors can be spaced apart so the camera does not obstruct their view). The image sensors are arranged in at least two different orientations to address the blind spot issue. Accordingly, the present disclosure provides a single camera that provides a combination of benefits from a conventional panoramic and a conventional fisheye camera without the FOV limitations and heavy distortion.

The hemispheric camera of the present disclosure may be configured for continuous monitoring or surveillance of a 360° area based on an all around view that includes the area below and above the camera. The hemispheric camera may comprise a pan tilt zoom (PTZ) camera component below a common image sensor and lens component that consists of four image sensors positioned so that the hemispheric camera can provide full FOV coverage above and below the camera (e.g., without blind spots above and below the camera). The full FOV coverage can be achieved as a full panoramic 360° without heavy distortion and blind spots based on stitching the respective images from the four image sensors together. For example, the video resolution of the hemispheric camera of the present disclosure is improved relative to a conventional fisheye camera.

As described in the present disclosure, the disclosed hemispheric camera will improve situational awareness and video surveillance based on the disclosed multi-sensor and co-located PTZ camera architecture of the hemispheric camera. In particular, the present disclosure provides a technical solution that improves video camera monitoring and surveillance based on providing a panoramic full hemispheric FOV (without blind spots or heavy distortion) which can cue/trigger the co-located PTZ camera to provide identification detail and other video analytics for objects or events of interest. Accordingly, the combined wide video surveillance coverage and PTZ video analytics of the disclosed hemispheric camera provides improved situational awareness. As an example, the disclosed camera may provide streaming video surveillance at approximately 16 megapixels and a true video resolution of twenty megapixels (e.g., four image sensors at 5 megapixels each).

According to one embodiment of the present disclosure, a computer-implemented method for improving generation of a full hemispheric video camera view with no blind spots is provided. The method includes positioning a plurality of image sensors in an interleaved configuration. The method includes generating, by a first type of the plurality of image sensors, a first type of image sensor view. The method includes generating, by a second type of the plurality of image sensors, a second type of image sensor view. The method includes stitching the first type of image sensor view and the second type of image sensor view together into a full hemispheric image sensor view. The method includes removing, based on the stitching into the full hemispheric image sensor view, a visual obstruction from the full hemispheric image sensor view.

According to one embodiment of the present disclosure, a system is provided including a processor configured to perform a method for improving generation of a full hemispheric video camera view with no blind spots. The system includes: a first plurality of image sensors arranged in a landscape configuration; a second plurality of image sensors arranged in a portrait configuration and in an interleaved configuration relative to the first plurality of image sensors; and the processor operatively in communication with the with the first plurality of image sensors and the second plurality of image sensors. The method includes receiving, from the first plurality of image sensors, a first type of image sensor view. The method includes receiving, from the second plurality of image sensors, a second type of image sensor view. The method includes stitching the first type of image sensor view and the second type of image sensor view together into a full hemispheric image sensor view. The method includes removing, based on the stitch into the full hemispheric image sensor view, a visual obstruction from the full hemispheric image sensor view.

According to one embodiment of the present disclosure, a video camera including a processor and a computer-readable storage medium is provided including instructions (e.g., stored sequences of instructions) that, when executed by the processor, cause the object detection device to perform a method for improving generation of a full hemispheric video camera view with no blind spots. The video camera includes: a first plurality of image sensors arranged in a landscape configuration; a second plurality of image sensors arranged in a portrait configuration and in an interleaved configuration relative to the first plurality of image sensors; and the processor operatively in communication with the with the first plurality of image sensors and the second plurality of image sensors. The method includes generating, via the first plurality of image sensors, a first type of image sensor view. The method includes generating, via the second plurality of image sensors, a second type of image sensor view. The method includes stitching the first type of image sensor view and the second type of image sensor view together into a full hemispheric image sensor view. The method includes removing, based on the stitch into the full hemispheric image sensor view, a blind spot in a field of view of the video camera.

Each of the above-mentioned embodiments will be discussed in more detail below, starting with example system and device architectures of the system in which the embodiments may be practiced, followed by an illustration of processing blocks for achieving an improved technical communication or data processing based method, device, and system for supporting rescue efforts in a building collapse scenario.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the drawings.

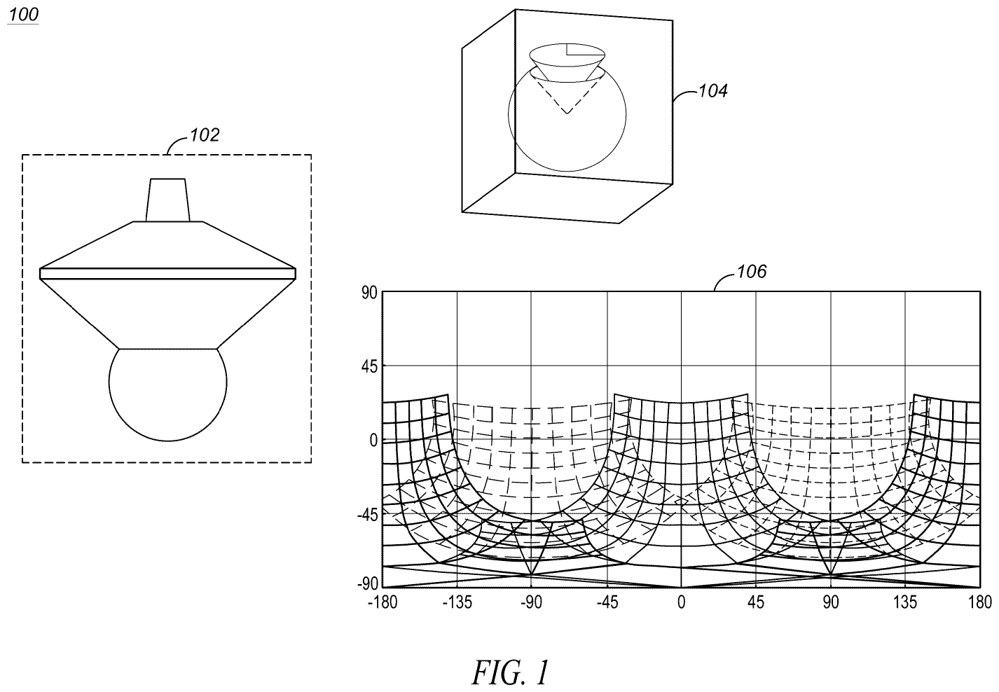

FIG. 1 depicts example configuration details 100 of a multisensor full hemispherical video camera 102, in accordance with some examples. An example video camera 102 is depicted that provides a full panoramic hemispheric view with no blind spots and without the heavy distortion inherent to conventional fisheye cameras. The hemispheric video camera 102 may comprise an upper image sensor housing and a lower sensor housing. The upper housing can contain multiple image sensors positioned (e.g., in an interleaved configuration) such that they provide individual sensor views that may be stitched together to a full hemisphere. As an example, the hemispheric video camera 102 can achieve a full hemisphere and 17° hemispherical sector FOV, as depicted in the illustration 104.

The multiple image sensors in the upper housing may be equally spaced radially (i.e., from the center of the camera), such as 90° spaced apart for good coverage into the stitched hemisphere FOV. For example, there may be four multiple image sensors alternating in landscape and portrait orientations. In such a configuration, the respective FOV of the four image sensors can be visualized in the graph 106 and can be stitched together to form the full hemispheric view. As shown in graph 106, there are overlapping portions for each of the spatial visualizations graphed in graph 106 for each of the four image sensors.

That is, the graph 106 can be understood as four respective FOV representations for each of the four image sensors. From left to right in graph 106, the first and third representations may correspond to portrait orientation image sensors while the second and fourth representations may correspond to landscape orientation image sensors. The two landscape image sensors can be tilted down 27° from the horizon and the two portrait image sensors can be tilted down 40° (relative to the horizon). The hemispheric video camera 102 can have a minimum 115° horizontal FOV (HFOV) f-theta lens and vertical FOV (VFOV) of 86.25° on a 4:3 aspect ratio. However, it will be understood that other configurations of the multiple image sensors may also be suitable. As described herein, the multisensor full hemispherical video camera 102 may represent a computational and cost improvement compared to a conventional fisheye camera that would require very expensive high resolution and accuracy lens to address the high distortion inherent to fisheye cameras.

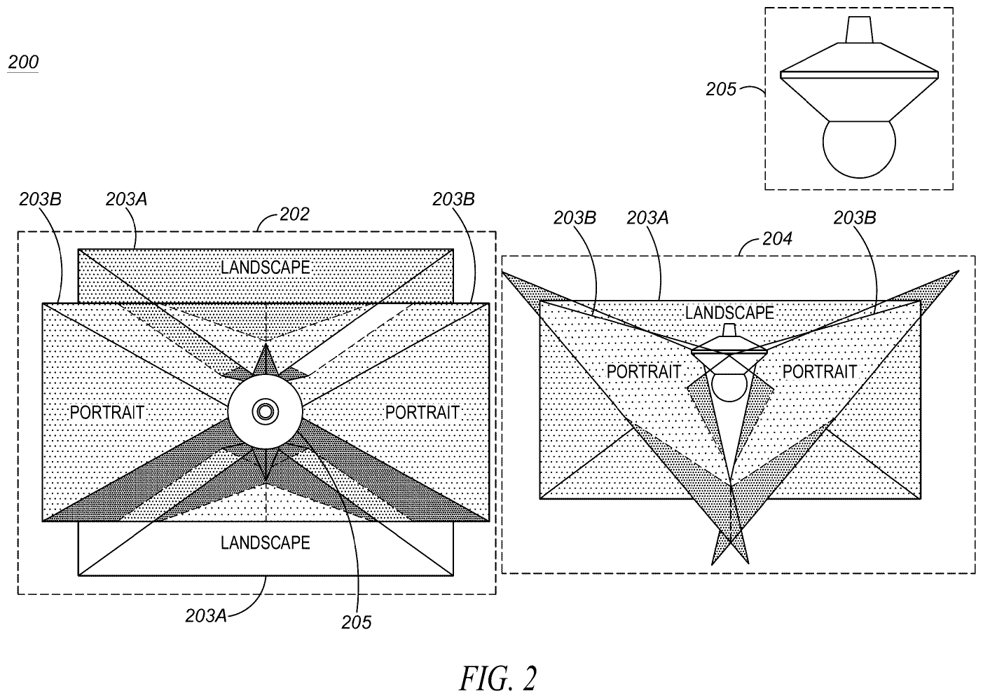

FIG. 2 depicts an illustration 200 of top 202 and front 204 views of an example full hemispherical video camera 205, in accordance with some examples. As can be seen in FIG. 2, the upper housing of the hemispherical video camera 205 can comprise a multi sensor panoramic camera component and the lower housing of the hemispherical video camera 205 can comprise a co-located PTZ camera. The multi sensor panoramic camera component may provide enhanced situational awareness via a complete hemispheric view. The co-located PTZ camera can be positioned or triggered based on video analytics from the multi sensor panoramic camera component in order to provide additional identification detail for surveillance.

The multi sensor panoramic camera component can comprise four sensors in an interleaved configuration shown in FIG. 2. Two landscape image sensors 203A are positioned in the interleaved configuration relative to two portrait image sensors 203B. For example, the two portrait image sensors 203A and the two landscape image sensors 203B may each have an aspect ratio of 4:3 with at least a HFOV of 115° and a VFOV of 86.25°. As another example, the two landscape image sensors 203A and the two portrait image sensors 203B may each output images or video at an aspect ratio of 16:9 (or 4:3). Other suitable aspect ratios may also be used. As illustrated in the front view 204, the full hemispherical video camera 205 can be configured such that the two landscape image sensors 203A are tilted down at an angle of at least 27° while the two portrait image sensors 203B are tilted down at an angle of at least 40°. The top view 202 illustrates the interleaved configuration of the multiple sensors in the video camera 205 which enables full FOV below and above the horizon plane of the video camera 205.

In particular, the top view 202 and the front view 204 both depict how the two landscape image sensors 203A and the two portrait image sensors 203B provide overlapping fields of view. As described herein, the overlapping FOV enables the hemispherical video camera 205 to stitch the landscape type of image sensor view and the portrait type of image sensor view together into a full hemispheric image sensor view. In contrast to conventional side by side or vertical edge stitching, the stitching algorithm(s) implemented by the hemispherical video camera 205 involve the horizontal and vertical edges/boundaries being stitched together. This stitching results in a continuous and seamless spherical view.

In this way, based on the stitching, visual obstructions (e.g., a part of the video camera 205 itself or other fixed or physical obstructions) can be removed so that no blind spots appear in the hemispheric FOV of the video camera 205. Advantageously, the design of the video camera 205 of the present disclosure requires a minimal number of sensors for effective hemispheric coverage. Accordingly, the present disclosure provides one common sensor plus lens design having below and above horizon views without any blind spots below the video camera 205 and without the heavy distortion inherent to conventional fisheye cameras. The video camera 205 may provide streaming video surveillance at approximately 16 megapixels and a true video resolution of twenty megapixels (e.g., four sensors at 5 megapixels each).

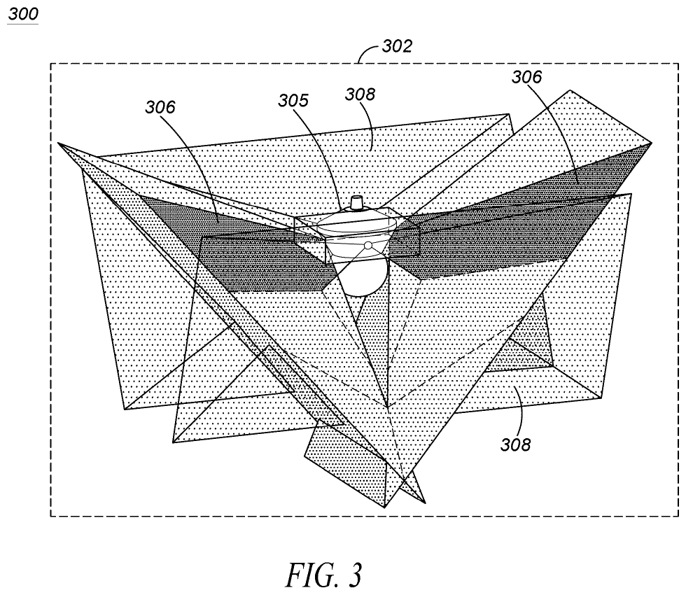

FIG. 3 is an illustration 300 that depicts an isometric view 302 of an example full hemispherical video camera 305, in accordance with some examples. The full hemispherical video camera 305 advantageously provides a cost efficient and no blind spot comprehensive spherical FOV through multiple staggered sensor view and stitching in contrast to conventional fisheye cameras which would require very expensive high resolution sensors and high accuracy lens to address the significant distortion issue with conventional fisheye cameras. Accordingly, the video camera 350 provides an improved means to achieve a full hemispheric coverage and removing obstructions/blind spots via stitching from multiple offset sensors. The isometric view 302 illustrates the respective FOV of four interleaved (e.g., staggered or offset) image sensors that are component parts of the video camera 305.

The respective FOV of the four sensors can be spaced radially so as to partially overlap and also cover, in combination, an entire spherical view. As shown in the isometric view 302 of FIG. 3, the two representations of portrait FOVs 306 and two representations of landscape FOVs correspond to the respective pairs of portrait image sensors (e.g., two portrait image sensors 203A) and landscape image sensors (e.g., the two landscape image sensors 203B) of the full hemispherical video camera 305. In this way, the upper housing of the video camera 305 containing the four image sensors beneficially provides the function of a single hemispherical lens via a stitching algorithm applied to the four separate sensor views.

Advantageously, the stitching and the positioning of the interleaved (e.g., alternating landscape and portrait orientations) and equally spaced (e.g., radially) four sensors enables a fixed obstruction to be visually removed from the hemispheric view of the video camera 305. As an example, the lower housing of the video camera 305 may contain a PTZ camera component that may otherwise cause a blind spot due to blocking the camera view but is addressed through the four sensor configuration which can generate a complete spherical sector imaging coverage despite having an obstruction (e.g., the PTZ camera component) directly beneath it. The advantages of this design include that the manufacturing cost and the design and manufacturing complexity (e.g. four common lens and sensor can be manufactured together) are reduced while also maintaining the image quality of the hemispheric view provided by the video camera 305 (e.g., in terms of pixels & degree). The co-located PTZ camera component in the lower housing of the video camera 305 may be configured to provide zoom in, pan, and title functionality to a user of the video camera 305.

For example, the PTZ component can be set to zoom in on a particular area, object, or event of interest. Because the multisensor hemispheric camera component provides a constant 360° spherical view all times, the PTZ camera component can enable zooming and investigation on a particular area or activity based on detection via the hemispheric camera component. For example, if the hemispheric camera component detects suspicious activity or anything that would trigger an alarm, the PTZ camera component may provide identification detail and any other information that requires finer video resolution based on that alarm/trigger/cue. Accordingly, the co-located PTZ camera component in the lower housing of the video camera 305 as shown in illustration 300 is capable of providing a better or clearer picture of an area that merits further investigation, monitoring, or surveillance.

The video camera 305 may provide streaming video surveillance at a range of seven to nine megapixels and a true video resolution of twenty megapixels (e.g., four image sensors at 5 megapixels each). For the multisensor hemispheric camera component of the video camera 305 to provide a complete hemispheric view with no blind spots, the video camera 305 is configured to stitch together the individual corresponding views of each of the constituent image sensors (e.g., the two landscape and two portrait image sensors referenced in FIG. 3).

The video camera 305 may apply a suitable stitching algorithm to stitch together horizontal and vertical edges/boundaries such that multiple video frames or streams from the constituent image sensors are combined to create a single, seamless panoramic or wide-angle view. Such a suitable stitching algorithm may involve performing techniques such as cross-correlation (e.g., to match adjacent images), feature-based stitching, pixel-based stitching, or homograph-based stitching. Such techniques may involve steps such as Scale-Invariant Feature Transform, Speeded-Up Robust Features, feature detector and descriptor steps, least squares optimization or graph cuts to determine and align overlapping regions, and/or calculation of homography matrix for alignment. The horizontal and vertical edge stitching implanted by the video camera 305 may be more effective than conventional side-by-side stitching or vertical edge stitching.

Furthermore, the video camera 305 can have object detection capabilities such that it operates to identify and disambiguate between different objects. In addition to the upper and lower housing components, the video camera 305 may also have other components including a memory, a processor operatively connected to the memory, a battery, a Bluetooth component, a microphone, and a speaker.

The memory can be configured to store data and be in operative communication with the processor for executing various operations. The memory may comprise volatile or non-volatile memory components, including but not limited to RAM (Random Access Memory), ROM (Read-Only Memory), flash memory, or any other suitable storage medium. The processor is configured to control the operation of the video camera, process captured images and videos, store identity and other information about detected objects, execute other algorithms for analysis and detection, and manage communication with external devices. The battery of the video camera 305 may ensure uninterrupted operation and enhanced mobility. The battery 606 stores and provides power to the various components of the video camera 305.

The Bluetooth component can support wireless connectivity via short-range wireless communication (e.g., 2.4 GHz ISM frequency band) with compatible devices by the video camera 305. The Bluetooth module may enable seamless pairing with smartphones, tablets, or other Bluetooth-enabled computing/communication devices, allowing users to remotely access and control the video camera 305. Moreover, Bluetooth connectivity provided by the Bluetooth component can facilitate data exchange, configuration, firmware updates, and other ad-hoc communication based capabilities. Although the video camera 305 is described as comprising the Bluetooth component, any other suitable wireless or wired communication method/component is also contemplated by the present disclosure. For example, the video camera 305 can use other wireless technology modalities such as Wi-Fi, Zigbee, RFID, Infared (IR communication), or Near Field Communication (NFC). As understood in the art, Wi-Fi may operate based on IEEE 802.11 standards allowing devices to communicate through access points, Zigbee may enable low-power wireless communication, RFID may enable wireless identification and tracking of objects via radio frequency (RF) signals, IR may enable wireless data communication with IR waves, and NFC may enable very short range wireless communication (e.g., devices in close proximity).

The video camera 305 also comprises a microphone and speaker suite to facilitate two-way audio communication. The speaker can perform playback of audio signals, including alerts, notifications, and voice messages. For example, the speaker can generate an audible alert indicating the presence of a danger, situation of note, or other object of interest. The microphone captures ambient sounds and user-generated audio inputs. For example, the microphone can capture audio response (e.g., human natural language for audio controlled commands) from users. The microphone and speaker may provide interactive capabilities for the video camera 305, enabling real-time communication between users and monitored areas, for example.

The video camera 305 may be a suitable high-resolution camera capable of capturing clear and detailed images and videos. As an example, the camera component can utilize advanced imaging technology, including but not limited to CMOS (Complementary Metal-Oxide-Semiconductor) sensors, lenses, and image processing algorithms, to perform its image capture functionality for video capture and/or surveillance. The camera component can have adjustable settings for resolution, frame rate, and exposure, such that it adapts to various lighting and environmental conditions to achieve optimal image quality and coverage. As discussed herein, the video camera 305 may provide a full seamless hemispheric 360° FOV via a multiple image sensor arrangement as well as pan, tilt, and zoom functionality via a co-located PTZ camera component. The video camera 305 may be fixed in place or it may be mobile.

As discussed herein, the video camera 305 may be a video camera for capturing video footage of a specific area for surveillance or monitoring purposes. The video camera 305 may include one or more image sensors used to convert light into electronic signals to capture images or video frames on the sensor's surface. The video camera 305 can be configured to perform processing, analysis, and other manipulation of images or videos that it has captured. Accordingly, the video camera 305 can identify characteristics of detected objects. The video camera 305 may perform analog to digital conversion (A-D conversion) of a captured analog video signal, transmission (e.g., real-time transmission over coaxial or Ethernet cables or wirelessly to a monitoring station or recording/storage medium), and control and monitoring. For example, the video camera 305 can have features such as pan, tilt, zoom (PTZ) functionality, motion detection, night vision (infrared illumination), and remote access for configuration and viewing via computer software, mobile apps, or web browsers. Video footage or analysis from the video camera 305 or any other cameras connected to it can be stored for later viewing, analysis, or archival purposes.

The video camera 305 may be connected to multiple other cameras or devices in a network, such as one that forms a security ecosystem as described herein. In this way, the security ecosystem can monitor multiple or broader areas for surveillance and monitoring. Furthermore, the video camera 305 may perform various video analytics algorithms which may or may not include ML/AI aspects. As an example, the video camera 305 can perform various computer vision techniques for object detection (e.g., identifying and locating objects of interest within video footage in real-time or offline). An example video object detection algorithm includes capturing an input video stream over time from a camera feed, pre-processing the frame to improve accuracy (e.g., resizing, normalization, noise reduction, color space conversion, etc.), object detection (e.g., using convolutional neural networks (CNNs) for recognizing objects by learning hierarchical features), feature extraction (e.g., to identify colors, textures, shapes and other visual characteristics for object recognition), object localization (e.g., with bounding boxes), classification, post-processing to refine results and improve accuracy, and output visualization. It will be understood that other suitable algorithms can be performed by the video camera 305.

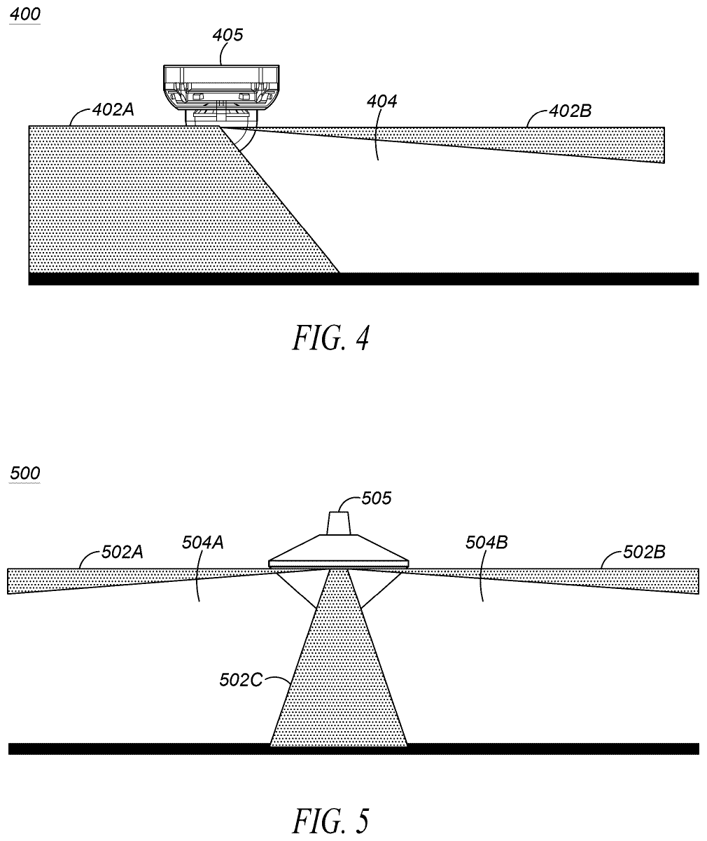

FIGS. 4-5 illustrates shortcomings of camera operation with various blind spots, in accordance with some examples. An example panoramic camera 405 is depicted in FIGS. 4-5. In contrast to the example full hemispherical video camera 102, 205, 305 described herein, the conventional panoramic camera 405 may have a limited FOV 404, 504A, 504B with intervening blind spots 402A, 402B, 502A, 502B, 502C that disadvantageously limit its video surveillance and monitoring capabilities. For example, the conventional panoramic camera 405 can have one or more blind spots including underneath the camera 405 where the camera 405 itself acts as an obstruction that blocks its view. This can be an issue because something of interest, such as an event that would trigger an alarm may need to be monitored and detected. Accordingly, the example full hemispherical video camera 102, 205, 305 of the present disclosure address this issue through improved situational awareness via the full 360° hemisphere FOV that does not suffer from blind spots.

As discussed herein, conventional fisheye cameras can prove a wide FOV up to 360° but have shortcomings in terms of heavy distortion and very low effective pixels per degree. Due to this image quality issue, conventional fisheye cameras generate wide FOV images that are challenging for effective implementation of camera video analytics and also are difficult for humans to interpret directly captured images. These disadvantages are addressed by the example full hemispherical video camera 102, 205, 305 described herein. The full hemispherical video camera 102, 205, 305 of the present disclosure advantageously does not require a user to employ separate camera devices or manually configure multiple cameras to obtain the necessary full spherical coverage. As discussed herein, wide 360° coverage of an area with no blind spots beneficially provides high situational awareness which improves video monitoring and surveillance capabilities of conventional cameras.

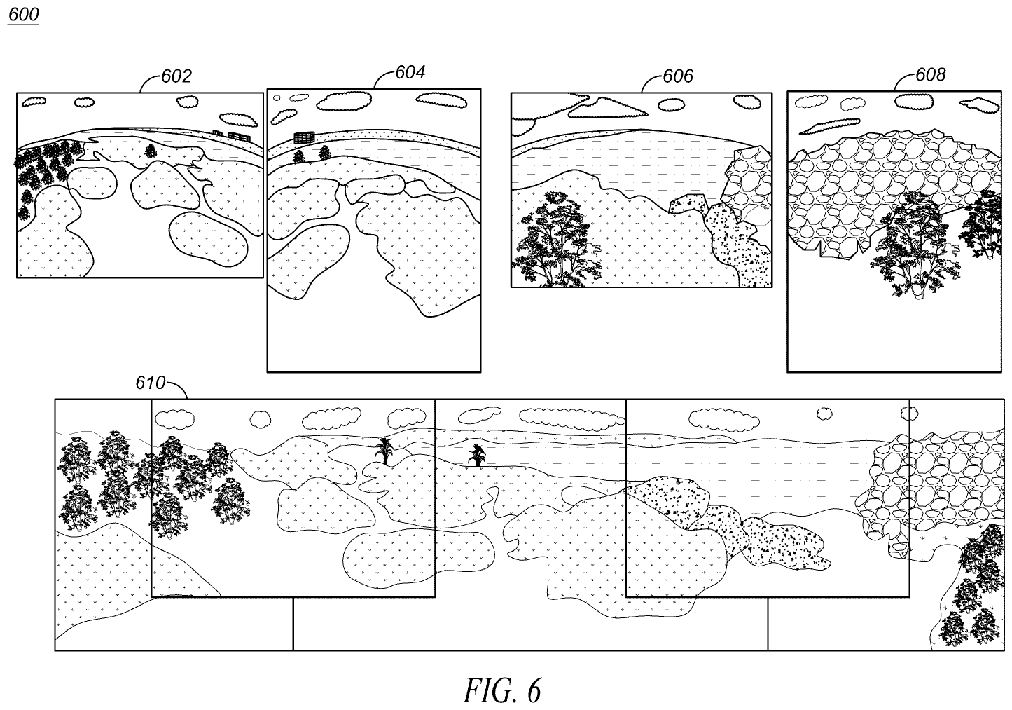

FIG. 6 illustrates a workflow 600 for stitching multiple sensor views together into a full hemispheric image sensor view 610, in accordance with some examples. In particular, four individual image sensor output views 602, 604, 606, 608 are determined and stitched together into the seamless full 360° spherical FOV. As shown in FIG. 6, there are image/video outputs from two portrait sensors and two landscape sensors, respectively. The two portrait image sensors and landscape image sensors may each have an aspect ratio of 4:3 or 16:9 with at least a minimum HFOV of 115° and minimum VFOV of 86.25°. Moreover, the two landscape image sensors can be tilted down at an angle of at least 27° while the two portrait image sensors can be tilted down at an angle of at least 40°. However, it will be noted that in other configurations, the tilt angles may be less than 27° and 40° respectively. This may be particularly true for portrait image sensors. As shown in the stitching workflow 600, the four constituent image sensors are arranged so that the combined view provides the full seamless full 360° spherical FOV.

The stitching employed in the workflow 600 can remove a visual obstruction from the full hemispheric image sensor view based on the lenses positioning of the image sensors, such as removing a fixed obstruction. As an example, the stitching can be used to remove the fixed obstruction caused by the positioning of a camera component (e.g., PTZ camera component in the upper housing of the example full hemispherical video camera 102, 205, 305) such that a blind spot in front of the camera is removed. Similarly, other blind spots that may be problematic in other conventional fisheye or other cameras advantageously may be removed. The stitching implemented by the example full hemispherical video camera 102, 205, 305 illustrated by the workflow 600 may be any suitable stitching algorithm effective for the orientation of the constituent image sensors.

For example, the implemented stitching as illustrated via the workflow 600 may be a horizontal/vertical edge based stitching. As an example, the example full hemispherical video camera 102, 205, 305 may determine horizontal and vertical edges or boundaries for a first type of image sensor view (e.g., landscape orientation) and a second type of image sensor view (e.g., portrait orientation). Thus, any pair or multiple grouping of image sensor views can be combined together via stitching based on the horizontal and vertical edges or boundaries. The stitching algorithm depicted in the workflow 600 can be feature-based stitching, pixel-based stitching, homograph-based stitching, or another suitable stitching variation. The employed stitching technique may involve steps such as Scale-Invariant Feature Transform, Speeded-Up Robust Features, feature detector and descriptor step, least squares optimization or graph cuts to determine and align overlapping regions, and/or calculation of homography matrix for alignment.

In the stitching workflow 600, the example full hemispherical video camera 102, 205, 305 may perform horizontal and/or vertical edge stitching, which involves aligning and merging multiple video or image frames in a side-by-side fashion to create a wide field of view or in a stacked top-by-top fashion to create a tall FOV. In this way, the four individual image sensor output views 602, 604, 606, 608 can be stitched together to the panoramic seamless 360° spherical coverage view 610. The performed horizontal and/or vertical edge stitching can involve steps including calibration so that the multiple (e.g., four) individual sensor outputs are overlapping FOV and can be pre-processed for aligning corresponding edges. Steps can also include blending the edges, adjusting for exposure, color, and sharpness differences between frames, and post-processing (e.g., correction, enhancement to remove defects or inconsistencies in picture/video).

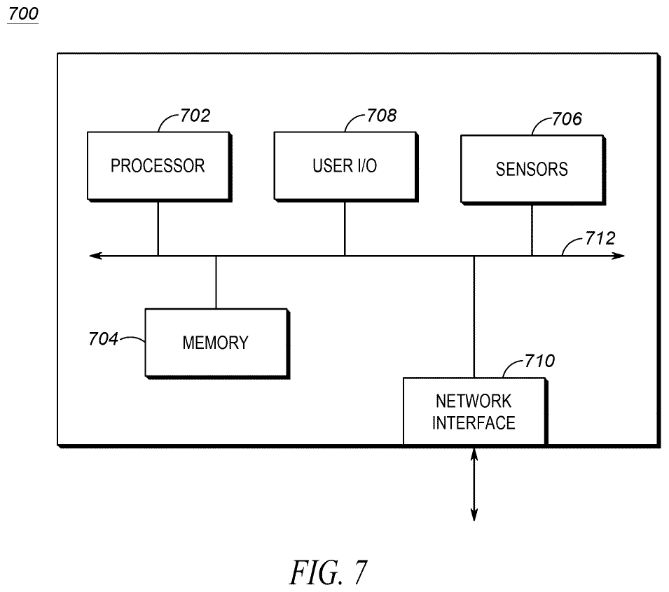

FIG. 7 illustrates a block diagram of an example electronic device, in accordance with some examples. In some embodiments, the computer device 700 may be a personal device, such as a UE, or a network device, or other equipment used in the network environment). The computer device 700 may include a physical device and/or a virtual device, such as a server running one or more virtual network functions (VNFs) of a network. In various examples, the computer device 700 may be a processor, a specialized computer, a personal or laptop computer (PC), a tablet PC, a mobile telephone, a smartphone, a network router, switch or bridge, a circuit such as an application specific integrated circuit (ASIC) or field programmable gate array (FPGA), or any machine capable of executing instructions (sequential or otherwise) that specify actions to be taken by that machine. In some embodiments, the computer device 700 may be an internet-of-things (IoT) or a narrowband IoT (NB-IoT) device or other device embedded within other, non-communication-based devices such as appliances or vehicles. The computer device 700 may render a full hemispherical horizontal FOV without blind spots and with effective picture and video resolution. In particular, the computer device 700 may stitch images from pairs of portrait and landscape image sensors as well as provide identification detail from a co-located PTZ camera component.

The computer device 700 may include various components connected by a bus 712. The computer device 700 may include a hardware processor 702 such as one or more central processing units (CPUs) or other processing circuitry able to provide any of the functionality described herein when running instructions. The processor 702 may be connected to a memory 704 may include a non-transitory machine-readable medium on which is stored one or more sets of instructions. The memory 704 may include one or more of static or dynamic storage, or removable or non-removable storage, for example. A machine-readable medium may include any medium that is capable of storing, encoding, or carrying instructions for execution by the processor 702, such as solid-state memories, magnetic media, and optical media. The machine-readable medium may include, for example, Electrically Programmable Read-Only Memory (EPROM), Random Access Memory (RAM), or flash memory.

The instructions may enable the computer device 700 to operate in any manner thus programmed, such as the functionality described specifically herein, when the processor 702 executes the instructions. The machine-readable medium may be stored as a single medium or in multiple media, in a centralized or distributed manner. In some embodiments, instructions may further be transmitted or received over a communications network via a network interface 710 utilizing any one of a number of transfer protocols (e.g., frame relay, internet protocol (IP), transmission control protocol (TCP), user datagram protocol (UDP), hypertext transfer protocol (HTTP), etc.).

The network interface 710 may thus enable the computer device 700 to communicate data and control information (e.g., security information) with other devices via wired or wireless communication. The network interface 710 may include electronic components such as a transceiver that enables serial or parallel communication. The wireless connections may use one or more protocols, including Institute of Electrical and Electronics Engineers (IEEE) Wi-Fi 802.11, Long Term Evolution (LTE)/4G, 5G, Universal Mobile Telecommunications System (UMTS), or peer-to-peer (P2P), for example, or short-range protocols such as Bluetooth, Zigbee, or near field communication (NFC). Wireless communication may occur in one or more bands, such as the 800-900 MHz range, 1.8-1.9 GHz range, 2.3-2.4 GHz range, 60 GHz range, and others, including infrared (IR) communications. Example communication networks to which computer device 700 may be connected via network interface 710 may include a local area network (LAN), a wide area network (WAN), a packet data network (e.g., the Internet), mobile telephone networks (e.g., cellular networks), and wireless data networks. Computer device 700 may be connected to the networks via one or more wired connectors, such as a universal serial bus (USB), and/or one or more wireless connections, and physical jacks (e.g., Ethernet, coaxial, or phone jacks) or antennas.

The computer device 700 may further include one or more sensors 706, such as one or more of an image sensor, metal sensor, accelerometer, a gyroscope, a global positioning system (GPS) sensor, a thermometer, a magnetometer, a barometer, a pedometer, a proximity sensor, a door sensor, or an ambient light sensor, among others. The sensors 706 may include some, all, or none of one or more of the types of sensors above (although other types of sensors may also be present), as well as one or more sensors of each type. The sensors 706 may be used in conjunction with one or more user input/output (I/O) devices 708 to indicate, on a user interface dashboard, events or objects of interest, such as for video surveillance and security. The user I/O devices 708 may include one or more of a display (e.g., a touch screen display of a mobile computing device), a camera, a speaker, a keyboard, a microphone, a mouse (or other navigation device), or a fingerprint scanner, among others. The user I/O devices 708 may include some, all, or none of one or more of the types of I/O devices above (although other types of I/O devices may also be present), as well as one or more I/O devices of each type.

The computer device 700 may include different specific elements depending on the particular device. For example, although not shown, in some embodiments, computer device 700 may include a front end that incorporates a millimeter and sub-millimeter wave radio front end module integrated circuit (RFIC) connected to the same or different antennae. The RFICs may include processing circuitry that implements processing of signals for the desired protocol (e.g., medium access control (MAC), radio link control (RLC), packet data convergence protocol (PDCP), radio resource control (RRC) and non-access stratum (NAS) functionality) using one or more processing cores to execute instructions and one or more memory structures to store program and data information. The RFICs may further include digital baseband circuitry, which may implement physical layer functionality (such as hybrid automatic repeat request (HARQ) functionality and encoding/decoding, among others), transmit and receive circuitry (which may contain digital-to-analog and analog-to-digital converters, up/down frequency conversion circuitry, filters, and amplifiers, among others), and RF circuitry with one or more parallel RF chains for transmit/receive functionality (which may contain filters, amplifiers, phase shifters, up/down frequency conversion circuitry, and power combining and dividing circuitry, among others), as well as control circuitry to control the other RFIC circuitry.

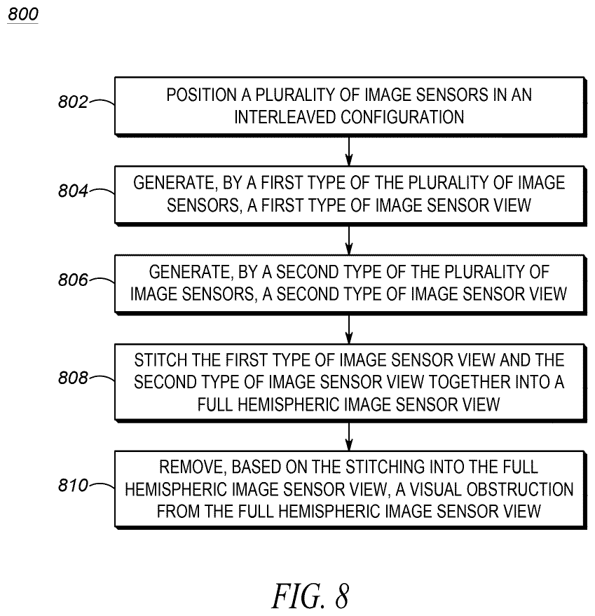

FIG. 8 illustrates an example flow diagram (e.g., process 800) to improve generation of a full hemispheric video camera view, according to certain aspects of the present disclosure. For explanatory purposes, the example process 800 is described herein with reference to one or more of the figures above. Further for explanatory purposes, the blocks of the example process 800 are described herein as occurring in serial, or linearly. However, multiple instances of the example process 800 may occur in parallel, overlapping in time, almost simultaneously, or in a different order from the order illustrated in the process 800. In addition, the blocks of the example process 800 need not be performed in the order shown and/or one or more of the blocks of the example process 800 need not be performed.

As an example, the process 800 can be performed by a first plurality of image sensors arranged in a landscape configuration and a second plurality of image sensors arranged in a portrait and interleaved configuration relative to the first plurality of image sensors as well as a processor in communication with the image sensors and a computer-readable storage medium, having stored thereon program instructions that, when executed by the processor, cause performance of the process 800. At step 802, a plurality of image sensors is positioned in an interleaved configuration. For example, positioning the plurality of image sensors comprises determining that the first type of the plurality of image sensors are a landscape type of image sensor. For example, positioning the plurality of image sensors comprises determining that the second type of the plurality of image sensors are a portrait type of image sensor.

For example, positioning the plurality of image sensors comprises interleaving the plurality of image sensors such that the interleaved configuration of the plurality of image sensors comprises an alternating configuration between a landscape orientation and a portrait orientation. For example, positioning the plurality of image sensors comprises arranging the plurality of image sensors as fixed camera heads in an equal radial spacing configuration. For example, positioning the plurality of image sensors comprises positioning the first type of the plurality of image sensors at a tilt down of at least 27 degrees. For example, positioning the plurality of image sensors comprises positioning the second type of the plurality of image sensors at a tilt down of at least 40 degrees.

At step 804, a first type of image sensor view is generated by a first type of the plurality of image sensors. For example, generating the first type of image sensor view comprises determining a horizontal field of view of at least 115 degrees arranged in a landscape orientation. For example, generating the first type of image sensor view comprises outputting, by two image sensors of the first type, an image in the landscape orientation with a 4:3 or 16:9 aspect ratio. Other suitable aspect ratios may be used. At step 806, a second type of image sensor view is generated by a second type of the plurality of image sensors. For example, generating the second type of image sensor view comprises determining a horizontal field of view of at least 115 degrees arranged in a portrait orientation. For example, generating the second type of image sensor view comprises outputting, by two image sensors of the second type, an image in the portrait orientation with a 4:3 or 16:9 aspect ratio.

At step 808, the first type of image sensor view and the second type of image sensor view are stitched together into a full hemispheric image sensor view. For example, stitching the first type of image sensor view and the second type of image sensor view together comprises determining horizontal and vertical edges or boundaries for the first type of image sensor view and the second type of image sensor view. For example, stitching the first type of image sensor view and the second type of image sensor view together comprises combining the first type of image sensor view and the second type of image sensor view together based on the horizontal and vertical edges or boundaries. At step 810, a visual obstruction (e.g., fixed obstruction) is removed from the full hemispheric image sensor view based on the stitching into the full hemispheric image sensor view.

According to an aspect, the process 800 comprises rendering the full hemispheric image sensor view as a 360 degree panoramic camera field of view including above and below a camera horizon. For example, the panoramic camera field of view may eliminate blind spots such that the field of view includes views above and below the video camera. According to an aspect, the process 800 comprises receiving, from the first plurality of image sensors, a first type of image sensor view. According to an aspect, the process 800 comprises receiving, from the second plurality of image sensors, a second type of image sensor view.

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, validate digital certificates, issue tokens, and the like).

In the foregoing specification, specific examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of”, without a more limiting modifier such as “only one of”, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
positioning a plurality of image sensors in an interleaved configuration;
generating, by a first type of the plurality of image sensors, a first type of image sensor view;
generating, by a second type of the plurality of image sensors, a second type of image sensor view;
stitching the first type of image sensor view and the second type of image sensor view together into a full hemispheric image sensor view; and
removing, based on the stitching into the full hemispheric image sensor view, a visual obstruction from the full hemispheric image sensor view.

2. The method of claim 1, wherein positioning the plurality of image sensors comprises:
determining that the first type of the plurality of image sensors are a landscape type of image sensor;
determining that the second type of the plurality of image sensors are a portrait type of image sensor; and
interleaving the plurality of image sensors such that the interleaved configuration of the plurality of image sensors comprises an alternating configuration between a landscape orientation and a portrait orientation.

3. The method of claim 1, wherein positioning the plurality of image sensors comprises arranging the plurality of image sensors as fixed camera heads in an equal radial spacing configuration.

4. The method of claim 1, wherein positioning the plurality of image sensors comprises:
positioning the first type of the plurality of image sensors at a tilt down of at least 27 degrees; and
positioning the second type of the plurality of image sensors at a tilt down of at least 40 degrees.

5. The method of claim 1, wherein generating the first type of image sensor view comprises:
determining a horizontal field of view of at least 115 degrees arranged in a landscape orientation; and
outputting, by two image sensors of the first type, an image in the landscape orientation with a 4:3 or 16:9 aspect ratio.

6. The method of claim 1, wherein generating the second type of image sensor view comprises:
determining a horizontal field of view of at least 115 degrees arranged in a portrait orientation; and
outputting, by two image sensors of the second type, an image in the portrait orientation with a 4:3 or 16:9 aspect ratio.

7. The method of claim 1, wherein stitching the first type of image sensor view and the second type of image sensor view together comprises:
determining horizontal and vertical edges or boundaries for the first type of image sensor view and the second type of image sensor view; and
combining the first type of image sensor view and the second type of image sensor view together based on the horizontal and vertical edges or boundaries.

8. The method of claim 1, further comprising rendering the full hemispheric image sensor view as a 360 degree panoramic camera field of view including above and below a camera horizon.

9. A system comprising:
a first plurality of image sensors arranged in a landscape configuration;
a second plurality of image sensors arranged in a portrait configuration and in an interleaved configuration relative to the first plurality of image sensors; and
a processor operatively in communication with the first plurality of image sensors and the second plurality of image sensors, wherein the processor, upon executing program instructions, is configured to:
receive, from the first plurality of image sensors, a first type of image sensor view;
receive, from the second plurality of image sensors, a second type of image sensor view;
stitch the first type of image sensor view and the second type of image sensor view together into a full hemispheric image sensor view; and
remove, based on the stitch into the full hemispheric image sensor view, a visual obstruction from the full hemispheric image sensor view.

10. The system of claim 9, wherein the processor is configured to receive the first type of image sensor view by being configured to:
determine a horizontal field of view of at least 115 degrees arranged in a landscape orientation; and
output, by two image sensors of the first plurality of image sensors, an image in the landscape orientation with a 4:3 or 16:9 aspect ratio.

11. The system of claim 9, wherein the processor is configured to receive the second type of image sensor view by being configured to:
determine a horizontal field of view of at least 115 degrees arranged in a portrait orientation; and
output, by two image sensors of the second plurality of image sensors, an image in the portrait orientation with a 4:3 or 16:9 aspect ratio.

12. The system of claim 9, wherein the processor is configured to stitch the first type of image sensor view and the second type of image sensor view together by being configured to:
determine horizontal and vertical edges or boundaries for the first type of image sensor view and the second type of image sensor view; and
combine the first type of image sensor view and the second type of image sensor view together based on the horizontal and vertical edges or boundaries.

13. The system of claim 9, wherein the processor is further configured to render the full hemispheric image sensor view as a 360 degree panoramic camera field of view including above and below a camera horizon.

14. The system of claim 9, wherein:
the first plurality of image sensors are positioned at a tilt down of at least 27 degrees; and
the second plurality of image sensors at positioned at a tilt down of at least 40 degrees.

15. An video camera comprising:
a first plurality of image sensors arranged in a landscape configuration;
a second plurality of image sensors arranged in a portrait configuration and in an interleaved configuration relative to the first plurality of image sensors; and
a processor operatively in communication with the first plurality of image sensors and the second plurality of image sensors; and
a computer-readable storage medium having stored thereon program instructions that, when executed by the processor, cause the video camera to perform a set of operations comprising:
generating, via the first plurality of image sensors, a first type of image sensor view;
generating, via the second plurality of image sensors, a second type of image sensor view;
stitching the first type of image sensor view and the second type of image sensor view together into a full hemispheric image sensor view; and
removing, based on the stitch into the full hemispheric image sensor view, a blind spot in a field of view of the video camera.

16. The video camera of claim 15, wherein the set of operations comprising generating the first type of image sensor view comprise:
determining a horizontal field of view of at least 115 degrees arranged in a landscape orientation; and
outputting, by two image sensors of the first plurality of image sensors, an image in the landscape orientation with a 4:3 or 16:9 aspect ratio.

17. The video camera of claim 15, wherein the set of operations comprising generating the second type of image sensor view comprises:
determining a horizontal field of view of at least 115 degrees arranged in a portrait orientation; and
outputting, by two image sensors of the second plurality of image sensors, an image in the portrait orientation with a 4:3 or 16:9 aspect ratio.

18. The video camera of claim 15, wherein the set of operations comprising stitching the first type of image sensor view and the second type of image sensor view together comprises:
determining horizontal and vertical edges or boundaries for the first type of image sensor view and the second type of image sensor view; and
combining the first type of image sensor view and the second type of image sensor view together based on the horizontal and vertical edges or boundaries.

19. The video camera of claim 15, wherein the set of operations further comprise rendering the full hemispheric image sensor view as a 360 degree panoramic camera field of view including above and below the video camera.

20. The video camera of claim 15, wherein:
the first plurality of image sensors are positioned at a tilt down of at least 27 degrees; and
the second plurality of image sensors at positioned at a tilt down of at least 40 degrees.
